(19) United States
(12) Patent Application Publication
(10) Pub. No.: US 2008/0295769 A1
(43) Pub. Date: Dec. 4, 2008

(54) THIN FILM FORMING APPARATUS AND THIN FILM FORMING METHOD

(76) Inventors: Masafumi Kawagoe, Kyoto (JP); Tomoyuki Komura, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/108,801

(22) Filed: Apr. 24, 2008

(30) Foreign Application Priority Data
May 29, 2007 (JP) 2007-141973

(51) Int. Cl. B05C 11/00

(52) U.S. Cl. 118/696

(57) ABSTRACT

A second plate is disposed opposing to a first plate. The second plate is supported by three supporting members which are disposed in a circle about a central axis. The supporting members are provided with extensible portions, respectively and are arranged to be able to extend and contract in a moving direction. A control unit drives to extend and to contract the extensible portions independently to displace the second plate in the moving direction at the supporting portion at which the supporting members support the second plate. Hence, the relative tilt of the second plate relative to the first plate is corrected.

### CROSS REFERENCE TO RELATED APPLICATION

The disclosure of Japanese Patent Application No. 2007-141973 filed May 29, 2007 including specification, drawings and claims is incorporated herein by reference in its entirety.

### BACKGROUND OF THE INVENTION

1. Field of the Invention

The present invention relates to a thin film forming apparatus and a thin film forming method which form a thin film on a substrate. It is to be noted that the substrate on which the thin film is formed includes various types such as semiconductor wafers, glass substrates for photomask, glass substrates for liquid crystal display, glass substrates for plasma display, substrates for FED (field emission display), substrates for optical disks, substrates for magnetic disks, and substrates for magnet-optical disks (hereinafter called simply a “substrate”).

2. Description of the Related Art

In recent years, with the growth in size such as a larger diameter wafer used in manufacturing LSI and a larger area liquid crystal panel and the like, a thin film forming method suitable for large area is required. Further, in a field of multilayer wiring technology in an LSI manufacturing technology, it is necessary to planarize a surface of insulating film with high precision in order to realize multilayer wiring. Hence, a demand for surface planarization technology has been increased in addition to a larger area in a thin film forming. Consequently, in order to meet these demands, a thin film forming technology which forms a thin film on a substrate through a pressurized transferring method has been proposed.

An apparatus arranged as follows, for instance, is known as the apparatus which performs such a thin film forming method (see JP-A-2001-135634 and JP-A-2003-151966). In these apparatuses, a substrate plate which has a heater built-in is provided in a thin film forming chamber which is formed inside a processing vessel. The substrate plate holds a substrate, which is a target of thin film forming, such as a semiconductor wafer and a glass substrate for liquid crystal panel. Further, inside the thin film forming chamber, a film plate is arranged below the substrate plate opposing to the substrate plate. The film plate holds a sheet film (equivalent to a “carrier” of the invention) while keeping a thin film formed on the sheet film opposing to the substrate on the substrate plate. Meanwhile, the film plate is also provided with a heater in the same way as the substrate plate. Hence, the sheet film held by the film plate can be heated. By moving the substrate plate which holds the substrate and the film plate which holds the sheet film close to each other, the substrate and the sheet film are pressed against each other so that the thin film on the sheet film is transferred to the substrate.

By the way, in order to transfer a thin film whose surface is flat and whose thickness is uniform to the substrate, it is required that the entire surface of the substrate is pressed against the sheet film with a uniform loading pressure. Consequently, the apparatus mentioned above is provided with a tilt correction mechanism as described below in an effort to solve this problem.

In the apparatus described in JP-A-2001-135634, the tilt correction mechanism holds the substrate plate rotatable and is arranged that a convex plate and a concave plate are biased in a direction in contact with each other, each of the convex plate and the concave plate having a spherical surface whose center is a middle of a surface of the substrate held by the substrate plate. And the tilt correction mechanism automatically corrects the tilt of the substrate plate relative to the film plate so that the substrate and thin film are pressed to each other with a pressure equal across the entire surface. Therefore, in the case where the substrate plate is tilted relative to the film plate, when the film plate is pressed to the substrate plate, the substrate plate turns in parallel to the spherical surfaces of the convex and the concave plates, the tilt of the substrate plate is corrected to be parallel with the film plate, and the substrate and the sheet film are pressed to each other with a loaded pressure uniform across the entire surface.

Further, in the apparatus described in JP-A-2003-151966, the tilt correction mechanism includes a first support and a second support. The first support is disposed in a manner that surrounds the outer circumference of a first plate (substrate plate), and supports the first plate rotatable, the rotation center being a first rotation axis extending in a first direction substantially orthogonal to a moving direction. The second support is disposed in the outer circumference of the first support and supports the first support rotatable, the rotation center being a second rotation axis extending in a second direction substantially orthogonal to the moving direction and to the first direction. Hence, the first plate is supported by the first support rotatable in the first direction and is supported by the second support rotatable in the second direction. Thus, the first plate can be tilted relative to the moving direction by means of a so-called axis rotating. Therefore, in the case where the first plate is tilted relative to the second plate (film plate), the tilt of the first plate is automatically corrected when the second plate hits the first plate.

### SUMMARY OF THE INVENTION

However, in the apparatuses described in JP-A-2001-135634 and JP-A-2003-151966, the structure of the apparatuses becomes complicated for correcting the relative tilt between the first plate and the second plate. Hence, there are cases that the tilt correction cannot be performed stably depending on the setting up of the apparatuses. As a result, it has become difficult to transfer the thin film to the substrate with a pressure distribution uniform within the surface.

The present invention has been made in light of the problem described above, and accordingly an object of the invention is to provide a thin film forming apparatus and a thin film forming method which stably corrects the relative tilt of the second plate relative to the first plate, whereby the thin film is transferred to the substrate with a pressure distribution uniform within the surface.

According to a first aspect of the invention, there is provided a thin film forming apparatus, comprising: a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film; a transferring unit that moves at least one of the first and the second plates in the moving direction, presses the substrate and the carrier to each other, and performs a transfer processing to transfer the thin film to the substrate; a plurality of supporting members which are disposed in a circle about an axis extending in the moving direction and passing through a center of the opposed surface of the second plate, are arranged to be able to adjust lengths in the moving direction thereof while supporting the second plate at supporting portions thereof; and a controller that controls the lengths of the respective supporting members in the moving direction at the supporting portion prior to the transfer processing or during the transfer processing to displace the second plate in the moving direction so that a relative tilt of the second plate relative to the first plate is corrected.

According to a second aspect of the invention, there is provided a thin film forming method using a thin film forming apparatus which comprises: a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film; and a plurality of supporting members which are disposed in a circle about an axis extending in the moving direction and passing through a center of the opposed surface of the second plate, are arranged to be able to adjust lengths in the moving direction thereof while supporting the second plate at supporting portions thereof, the method comprising: a transferring step of moving at least one of the first and the second plates in the moving direction, pressing the substrate and the carrier to each other, and performing a transfer processing to transfer the thin film to the substrate; and a tilt correction step of controlling the lengths of the respective supporting members in the moving direction at the supporting portion prior to the transferring step or during the transferring step to displace the second plate in the moving direction so that a relative tilt of the second plate relative to the first plate is corrected.

According to the invention, the second plate is supported by the plurality of supporting members disposed in a circle about the axis extending in the moving direction and passing through the center of the opposed surface of the second plate. And the lengths of the respective supporting members in the moving direction at the supporting portion are controlled prior to the transfer processing or during the transfer processing. Hence, the second plate can be displaced in the moving direction and the relative tilt of the second plate relative to the first plate can be corrected. Therefore, it becomes possible to perform the tilt correction stably regardless of the state of setting up of the apparatus, and the thin film can be transferred to the substrate with a pressure distribution uniform within the surface.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing a first embodiment of a thin film forming apparatus according to this invention.

FIG. 2 is a cross sectional view for describing the ring unit and an arrangement of sandwiching to hold the ring unit.

FIG. 3 is a transverse sectional view taken on line A-A of the thin film forming apparatus of FIG. 1.

FIGS. 4A and 4B are sectional views of a main part of the thin film forming apparatus of FIG. 1.

FIG. 5 is a flow chart showing an operation of the thin film forming apparatus of FIG. 1.

FIGS. 6A to 6C, 7A to 7C and 8A to 8C are schematic diagrams for describing an operation of the transfer processing.

FIGS. 9A and 9B are diagrams showing main parts of a second embodiment of the thin film forming apparatus according to the invention.

FIG. 10 is a block diagram showing a part of a control arrangement for controlling the thin film forming apparatus of FIGS. 9A and 9B.

FIG. 11 is a flow chart showing an operation of the transfer processing of the thin film forming apparatus of FIG. 9.

FIG. 12 is a timing chart showing a state of loading pressure and of applied voltage in each of the supporting members.

FIG. 13 is a timing chart showing a state of loading pressure and of applied voltage in each of the supporting members in the second transfer processing.

### DETAILED DESCRIPTION OF THE PREFERRED EMBODIMENTS

### First Embodiment

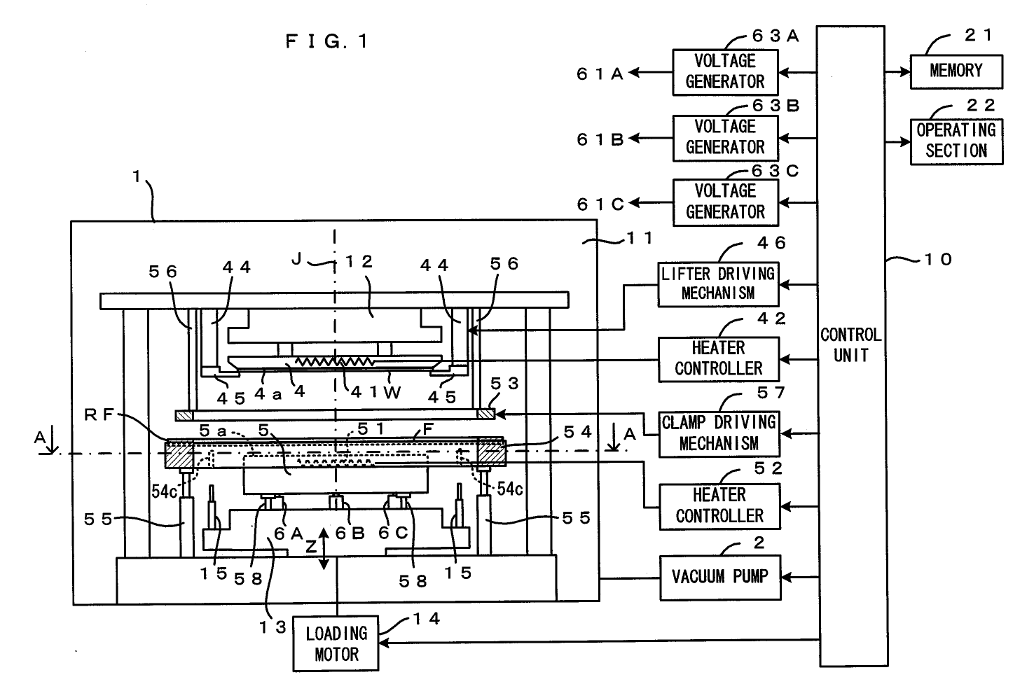

FIG. 1 is a diagram showing a first embodiment of a thin film forming apparatus according to this invention. This thin film forming apparatus is provided with a processing vessel 1 whose inside is a thin film forming chamber 11 which performs a transfer processing as described hereinafter. This thin film forming chamber 11 can be evacuated with a vacuum pump 2 during the transfer processing. This vacuum pump 2 is electrically connected to a control unit 10 (equivalent to a “controller” of the invention) which controls the entire apparatus, and thus, the vacuum pump 2 is activated according to an operation command from the control unit 10 and can evacuate the thin film forming chamber 11.

The thin film forming chamber 11 contains a first and a second plates 4, 5 opposing to each other and in an upper part and in a lower part respectively. The first plate 4 is fixedly supported horizontally by a base member 12 which is fixedly disposed inside the thin film forming chamber 11, and is positioned above the second plate 5. The first plate 4 is arranged as a sample platform on which a substrate W is mounted. A bottom surface 4a of the first plate 4 opposing to the second plate 5 functions as a mounting surface of the substrate W. Here, the substrate W which is a target of a thin film forming, for instance, includes a disc shaped semiconductor wafer, and the semiconductor wafer on which a wiring pattern of electrodes are formed. A thin film such as an insulating film is transferred to the pattern forming surface of the substrate W.

The bottom surface 4a of the first plate 4 is provided with a quarts plate (not shown) which is polished for the purpose of securing a flat surface, and the substrate W is mounted on the quartz plate. Quartz is an excellent material for mounting the substrate W because it does not contain a substance which contaminates the substrate W, and it has an excellent workability so that a necessary flatness is easily obtained. The first plate 4 is equipped with a heater 41 inside thereof as a heating unit. This heater 41 is electrically connected to a heater controller 42. The heater controller 42 is activated based on the substrate temperature information from the control unit 10, whereby the heating is controlled between 25 degrees centigrade and 300 degrees centigrade.

The first plate 4, which is arranged as described above, is supported by a plurality (two in this embodiment) of lifters 44 to be freely movable up-and-down and horizontally. Tab members 45 are fixedly placed at a lower end of each of the lifers 44. Top surfaces of the respective tab members 45 are made to be engageable with a circumferential portion of the substrate W so that the substrate W can be placed on the tab members 45. Each of the lifters 44 is connected with a lifter driving mechanism 46. The lifter driving mechanism 46 is activated in accordance with an operation command from the control unit 10, so that the plurality of lifters 44 can be moved integrally to a substrate loading position and to a substrate mounting position (position shown in FIG. 1), the substrate loading position being a position at which the substrate W which has been loaded in the thin film forming chamber 11 can be placed on the tab members 45, the substrate mounting position being a position at which the substrate W which has been placed on the tab members 45 is mounted to the bottom surface 4a of the first plate 4.

Specifically, when a command is given from the control unit 10 to the lifter driving mechanism 46 to descend, the lifters 44 move downward, and the tab members 45 are moved to a position below the bottom surface 4a of the first plate 4, and then the lifters 44 are moved horizontally to a position at which the tab members 45 oppose to and away from a bottom surface of a circumferential portion of the first plate 4. Accordingly, the tab members 45 are positioned at the substrate loading position, thereby allowing the substrate W to be placed on the tab members 45. Further, when a command is given from the control unit 10 to the lifter driving mechanism 46 to ascend, the lifter driving mechanism 46 moves the lifters 44 upward to closely contact the substrate W on the tab members 45 with the bottom surface 4a of the first plate 4. This causes the tab members 45 to be positioned at the substrate mounting position, and the substrate W is mounted to the first plate 4.

The second plate 5 is arranged below the first plate 4 with the respective axes aligned and opposed to each other, and is supported by a plurality (three in this embodiment) of supporting members 6A, 6B and 6C which are to be described hereinafter. The second plate 5 is arranged as a transferring plate to which a sheet film F (equivalent to a “carrier” of the invention) is mounted. A top surface 5a of the second plate 5 which is opposed to the first plate 4 functions as a mounting surface of the sheet film F equivalent to an “opposing surface” of the second plate of the invention. This sheet film F is formed in a round shape larger than the substrate W with a thin film formed on a surface thereof. The top surface 5a of the second plate 5 is provided with a quarts plate (not shown) in the same way as the first plate 4. The second plate 5 is equipped with a heater 51 inside thereof as a heating unit. This heater 51 is electrically connected to a heater controller 52. The heater controller 52 is activated based on the substrate temperature information from the control unit 10, whereby the heating is controlled between 25 degrees centigrade and 300 degrees centigrade.

Three supporting members 6A, 6B, 6C are provided on a base member 13 so as to protrude therefrom, the base member 13 being provided freely movable up and down in a moving direction Z inside the thin film forming chamber 11. A loading motor 14 (equivalent to a “moving mechanism” of the invention) is connected to the base member 13. The loading motor 14 is driven according to an operation command from the control unit 10, whereby the base member 13 can be moved up and down in the moving direction Z. Therefore, elevating the base member 13 will elevate the plurality of supporting members 6A, 6B and 6C and the second plate 5 supported on the plurality of supporting members 6A, 6B and 6C integrally with the base member 13.

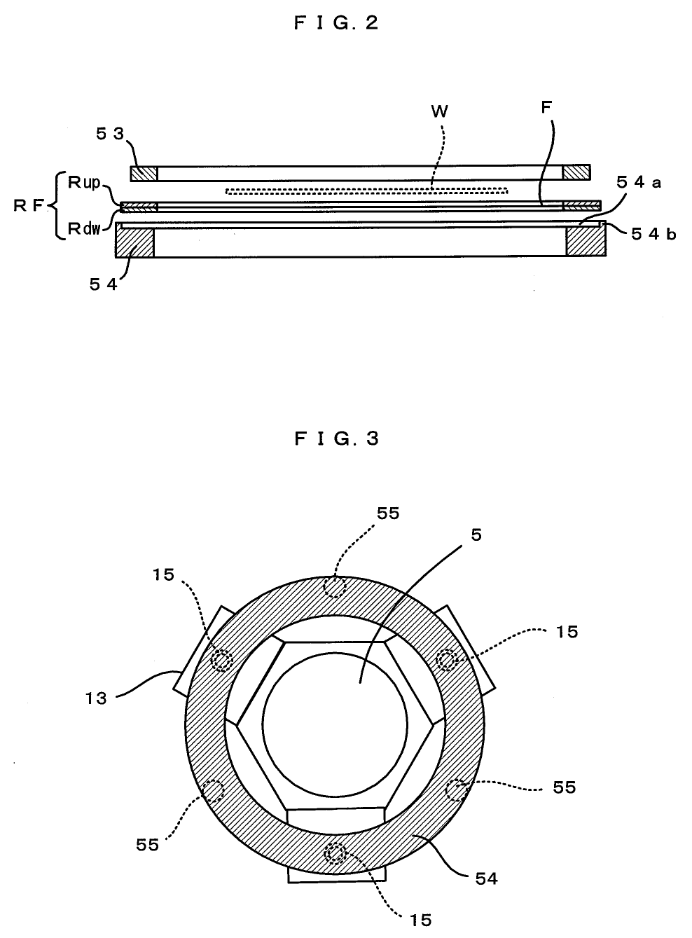

Further, in this embodiment, in order to improve handling ability of the sheet film F, an integrated ring unit RF is formed by using a pair of rings Rup, Rdw as shown in FIG. 2, and a transportation of the sheet film F is performed in a condition of the ring unit RE Description is made hereinafter on the handling arrangement of the sheet film F with reference to FIGS. 1 and 2.

FIG. 2 is a cross sectional view for describing the ring unit and an arrangement of sandwiching to hold the ring unit. This ring unit RF holds the sheet film F by sandwiching the sheet film F between a top ring Rup and a bottom ring Rdw. Each of the top ring Rup and the bottom ring Rdw has the same shape of a ring-shaped member. The top ring Rup and the bottom ring Rdw are arranged with the sheet film F in between, whereby the sheet film F can be held through magnetic adsorption.

Further, a top clamp 53 and a bottom clamp 54 are disposed around the first and the second plates 4, 5 for holding the ring unit RF by sandwiching a pair of rings Rup and Rdw from above and below. The top clamp 53 and the bottom clamp 54 are ring-shaped members having substantially the same inside diameters as the pair of rings Rup and Rdw. An outside diameter of the top clamp 53 is smaller than that of the pair of rings Rup and Rdw, whereas an outside diameter of the bottom clamp 54 is larger than that of the pair of rings Rup and Rdw.

FIG. 3 is a transverse sectional view taken on line A-A of the thin film forming apparatus of FIG. 1. Out of the two clamps, the bottom clamp 54 is placed in a horizontal posture on a plurality (three in this embodiment) of clamp receivers 55 which are installed upright on a bottom plate in the thin film forming chamber 11. The clamp receivers 55 are disposed in a circle at an equiangular distance (120 degrees) from each other around an axis J (hereinafter simply called a “central axis”) which extends in the moving direction Z passing through a center of the top surface 5a of the second plate 5. A concave portion 54a which is concaved inwardly and capable of putting a bottom portion (the bottom ring Rdw) of the ring unit RF is formed on a top circumferential portion (ring portion) of the bottom clamp 54 (FIG. 2). And, the bottom portion of the ring unit RF is put in the concave portion 54a, whereby the circumferential surface portion 54b which surrounds the circumference of the concave portion 54a prevents the ring unit RF from moving horizontally.

Further, on the base member 13, a plurality (three in this embodiment) of clamp raising pins 15 are installed upright in a circle at an equiangular distance (120 degrees) from each other around the central axis J. The clamp raising pins 15 are positioned between the clamp receivers 55 along the circumference. On the other hand, pin insertion holes 54c, into which the leading end of the clamp raising pins 15 can be inserted, are formed on the bottom surface of the bottom clamp 54 corresponding to the respective clamp raising pins 15. Hence, when the base member 13 is driven to ascend, the leading ends of the clamp raising pins 15 are inserted into the pin insertion holes 54c, and steps formed between the leading ends and rear ends of the clamp raising pins 15 abut on a bottom surface of the bottom clamp 54. Therefore, when the base member 13 is driven to ascend further, the bottom clamp 54 moves away from the clamp receivers 55 and ascends integrally in a state that the clamp raising pins 15 and the bottom clamp 54 are in engagement.

Further, the other clamp, that is, the top clamp 53 is fixed on lower ends of a plurality of lifters 56 which are supported freely elevatable. A clamp driving mechanism 57 is connected to the lifters 56. The top clamp 53 can be moved up and down by activating the clamp driving mechanism 57 in accordance with an operation command from the control unit 10. Specifically, the top clamp 53 is moved upward to enable loading and unloading of the ring unit RF to and from the second plate 5, whereas the top clamp 53 is moved downward so that the ring unit RF is sandwiched between the top clamp 53 and the bottom clamp 54 to be fixed.

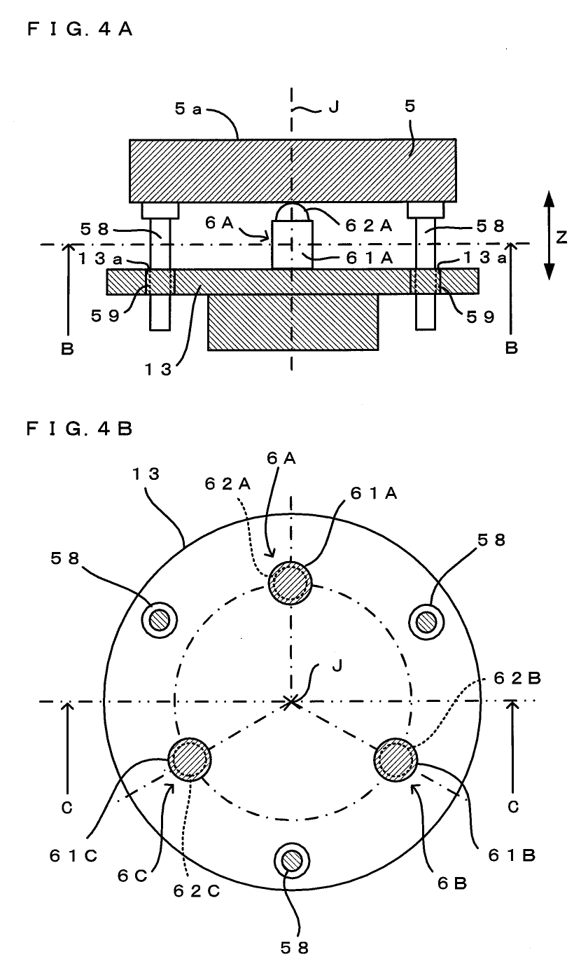

FIGS. 4A and 4B are sectional views of a main part of the thin film forming apparatus of FIG. 1. Specifically, FIG. 4A is a longitudinal sectional view (longitudinal sectional view taken on line C-C of FIG. 4B) and FIG. 4B is a transverse sectional view (transverse sectional view taken on line B-B of FIG. 4A). The three supporting members 6A, 6B, 6C are disposed on the base member 13 so as to project therefrom. The three supporting members 6A, 6B, 6C are disposed in a circle around the central axis J at an equiangular distance (120 degrees) from each other. Since the three supporting members 6A, 6B, 6C are arranged in the same way, the arrangement of one supporting member 6A is described herein, while the supporting members 6B and 6C are represented by equivalent reference characters and description thereof is dispensed with.

As shown in FIG. 4A, the supporting member 6A includes an extensible portion 61A and an abutting portion 62A (equivalent to a “supporting portion” of the invention). The extensible portion 61A can extend and shorten in the moving direction Z. A piezo actuator which extends and shortens in accordance with the applied voltage is preferably used as the extensible portion 61A. The piezo actuator has a relatively large thrust force and is capable of performing a minimal amount of extending and shortening drive. Hence, it is possible to finely control a tilt of the second plate 5 relative to the first plate 4 as described hereinafter. In this embodiment, the piezo actuator having a diameter of 20-40 mm and a plurality of piezoelectric bodies which are multiply-layered is used for example. Further, the abutting portion 62A is a hemispherical member which is attached on a top surface of the extensible portion 61A, and is capable of point contact to a bottom surface of the second plate 5. Hence, the second plate 5 is supported in a horizontal posture and in a state of point contact by the supporting members 6A, 6B and 6C. Meanwhile, an actuator using magnetostrictor or an electric actuator which is a combination of a motor and a reduction gear may be used as the extensible portion instead of the piezo actuator.

The control unit 10 is capable of controlling extension and contraction of the extensible portions 61A, 61B and 61C independently. Specifically, the extensible portions 61A, 61B, 61C are connected with voltage generators 63A, 63B, 63C (FIG. 1), respectively. Predetermined voltages are applied from the respective voltage generators 63A, 63B and 63C, whereby the extensible portions 61A, 61B, 61C are extended or contracted in the moving direction Z according to the applied voltages. As a result, lengths of the supporting members 6A, 6B, 6C in the moving direction Z are adjusted in accordance with the applied voltages. Hence, when a voltage control command is given from the control unit 10 to the voltage generators 63A, 63B and 63C, the voltages in accordance with the voltage control command are applied from the voltage generators 63A, 63B and 63C to the extensible portions 61A, 61B and 61C, respectively, thereby causing the extensible portions 61A, 61B and 61C to extend or contract in the moving direction Z according to the applied voltages. This causes the second plate 5 to be displaced in the moving direction Z at the abutting portions 62A, 62B, 62C while each of the supporting members 6A, 6B, 6C supports the second plate 5. Specifically, the supporting members 6A, 6B, 6C are extended, whereby the second plate 5 is pressed at the abutting portions 62A, 62B, 62C to be displaced upward, whereas the supporting members 6A, 6B, 6C are contracted, whereby the second plate 5 is displaced downward at the abutting portions 62A, 62B, 62C due to its own weight. Therefore, the three supporting members 6A, 6B, 6C are driven to extend and contract independently, whereby a relative tilt of the second plate 5 relative to the first plate 4 is freely adjusted. Hence, it is possible to perform a tilt correction so that the top surface 5a of the second plate 5 is in parallel with the bottom surface 4a of the first plate 4 by independently controlling the length of each of the supporting members 6A, 6B, 6C in the moving direction Z.

A plurality of positioning pins 58 are attached extending downward on a circumferential portion of the bottom surface of the second plate 5 in order to fix a position of the second plate 5 in the horizontal direction. These positioning pins 58 penetrate through holes 13a which are formed in the base member 13 extending in the vertical direction. Bushes 59 are fitted into a space between the positioning pins 58 and the through holes 13a. The positioning pins 58 are supported by the bushes 59 to be freely movable (elevatable) in the moving direction Z. With a construction like this, it is possible to always match the axis line of the second plate 5 with that of the first plate 4, even when the second plate 5 is displaced by the respective supporting members 6A, 6B and 6C. Specifically, the center of the bottom surface 4a of the first plate 4 is always positioned on the central axis J which passes through the center of the top surface 5a of the second plate 5.

Further, the thin film forming apparatus comprises a memory 21 including a RAM in which data and the like are temporarily stored, and a ROM in which a control program and the like are stored, and an operating section 22 including a keyboard for example as a user interface.

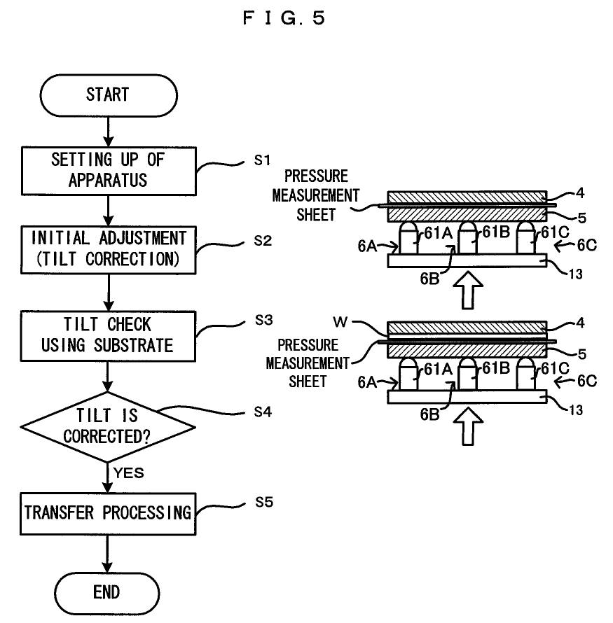

Next, description is made on a thin film forming procedure using the thin film forming apparatus described above with reference to FIG. 5. FIG. 5 is a flow chart showing an operation of the thin film forming apparatus of FIG. 1. In this embodiment, upon completion of setting up the thin film forming apparatus (Step S1), initial adjustment (tilt correction) of the apparatus is performed (Step S2). Specifically, the second plate 5 is moved upward to be pressed against the first plate 4 in a condition that a film-type pressure measurement sheet for measuring a pressure distribution within a surface of the plate is sandwiched between the first plate 4 and the second plate 5. The pressure measurement sheet is provided with a number of sensing points for measuring the pressure distribution within the surface so that the pressure distribution within the surface can be understood based on the output signal from the pressure measurement sheet. Here, in the case where a variation in the pressure distribution within the surface is greater than or equal to a predetermined amount, an operator changes a voltage applied to the supporting members 6A, 6B, 6C (extensible portions 61A, 61B, 61C) as necessary by operating the operating section 22. The relative tilt of the second plate 5 relative to the first plate 4 is thus corrected so that the pressure distribution within the surface is uniform. For example, in the case where a pressure of a specific region within the surface is higher than the other region, the supporting members positioned close to the specific region are contracted, thereby displacing the second plate 5 downward at the supporting portion of the supporting members and reducing the pressure of the region. Alternatively, the supporting members positioned close to the region where the pressure is lower are extended, thereby displacing the second plate 5 upward at the supporting portion of the supporting members and increasing the pressure of the region.

The length of each of the supporting members 6A, 6B and 6C in the moving direction Z is thus adjusted so as to keep the variation of the pressure distribution within the surface below the predetermined amount. This completes an initial adjustment and corrects the relative tilt of the second plate 5 relative to the first plate 4. Further, the voltage data corresponding to the applied voltages (hereinafter called “corrected voltages”) to the respective supporting members 6A, 6B, 6C which are set in a tilt corrected condition are stored in the memory 21. Subsequently, the pressure distribution within the surface is confirmed in a state that the substrate W which is subject to thin film forming is sandwiched in addition to the pressure measurement sheet between the first plate 4 and the second plate 5 in order to verify that the tilt correction is performed without fail (Step S3). Specifically, the corrected voltage is applied to each of the supporting members 6A, 6B and 6C from each of the voltage generators 63A, 63B and 63C, and the second plate 5 is pressed against the first plate 4 in a state that the substrate W and the pressure measurement sheet are sandwiched between the first plate 4 and the second plate 5. When the variation of the pressure distribution within the surface is below the predetermined amount, that is, when it is considered that the tilt is corrected (YES at Step S4), transfer processing (transferring step) is subsequently performed (Step S5).

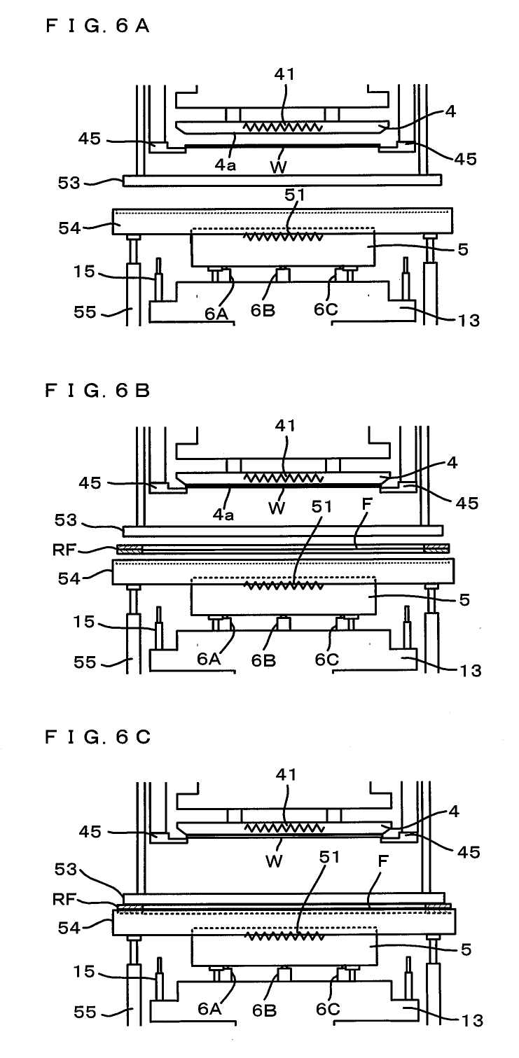

FIGS. 6A to 6C, 7A to 7C and 8A to 8C are schematic diagrams for describing an operation of the transfer processing. In this embodiment, the substrate W is loaded to a side of the first plate 4. Specifically, the control unit 10 provides a descending command to the lifter driving mechanism 46 to position the tab members 45 at the substrate loading position as shown in FIG. 6A. Subsequently, the substrate W, on which a thin film is to be formed, is loaded into the thin film forming chamber 11 and is placed on the tab members 45. Thereafter, the control unit 10 provides an ascending command to the lifter driving mechanism 46 to move the tab members 45 to the substrate mounting position to position the substrate W in a state that the top surface (non-pattern forming surface) of the substrate W is closely contact with the bottom surface 4a of the first plate 4 (FIG. 6B). On the other hand, at a side of the second plate 5, the ring unit RF is loaded into the thin film forming chamber 11. Then, after the ring unit RF is placed on the bottom clamp 54, the top clamp 53 descends toward the bottom clamp 54 so that the ring unit RF is sandwiched to be held between the top clamp 53 and the bottom clamp 54 (FIG. 6C). Here, a thin film is formed in advance on the sheet film F which is sandwiched between the pair of rings Rup and Rdw which compose the ring unit RF. The sheet film F is arranged at the position above the second plate 5 with the thin film facing up.

When the loading and mounting of the substrate W and the sheet film F are completed, the control unit 10 controls respective parts of the apparatus in accordance with the transferring program stored in the memory 21 in advance, and the thin film is transferred to the substrate W as described below. At this time, the voltage data corresponding to the corrected voltages are read out from the memory 21, and the corrected voltages are applied from the voltage generators 63A, 63B and 63C to the supporting members 6A, 6B and 6C, respectively. As a result, prior to the application of the pressure of the second plate 5 against the first plate 4, the relative tilt of the second plate 5 relative to the first plate 4 is corrected during the application of the pressure.

Subsequently, the vacuum pump 2 starts to depressurize the thin film forming chamber 11. Further, the heater controller 42 turns of the heater 41 to heat the first plate 4, thereby heating the substrate W to a desired temperature, and the heater controller 52 turns of the heater 51 to heat the second plate 5, thereby heating the sheet film F to a desired temperature.

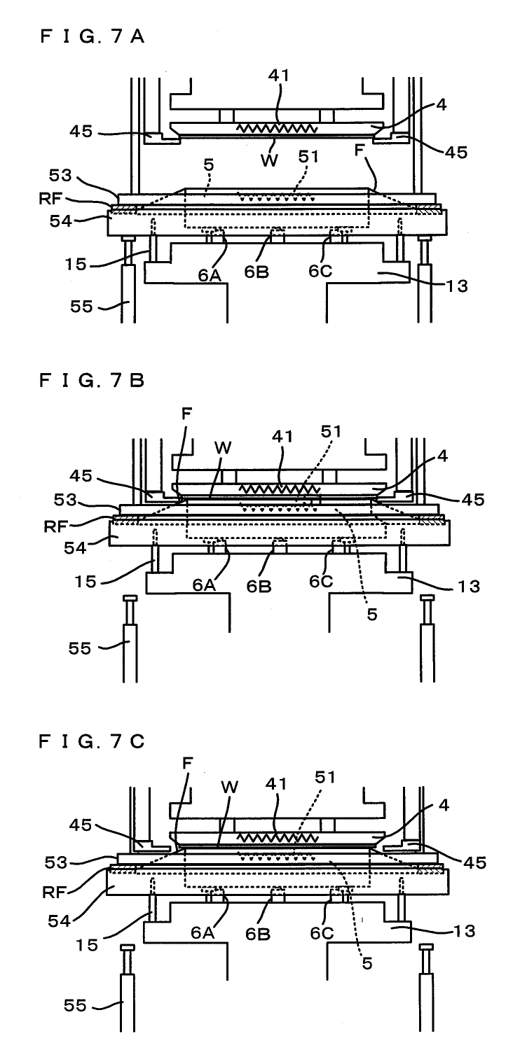

Then, when the thin film forming chamber 11 is depressurized to a desired pressure, the control unit 10 sends a signal to the loading motor 14 to start driving the base member 13 and the second plate 5 to ascend. The second plate 5 thus ascends in the moving direction Z to increase tension of the sheet film F in a state that the top surface 5a of the second plate 5 is in contact with the sheet film F. As a result, a slack of the sheet film caused by heat expansion is eliminated. Further, the base member 13 ascends, whereby the bottom clamp 54, which is placed on the clamp receiver 55, is handed over to the clamp raising pins 15 which are erected on the base member 13 (FIG. 7A).

When the base member 13 is driven to ascend further, the bottom clamp 54 is separated from the clamp receivers 55, and the top clamp 53, the ring unit RF and the bottom clamp 54 ascend integrally while being supported on the base member 13 in a state that the tension of the sheet film F is maintained. Thus, the thin film on the sheet film F adheres to the substrate W to start the transferring of the thin film to the substrate W (FIG. 7B). Then, the substrate W and the sheet film F are pressed to each other with a predetermined load for a given period of time with the thin film forming chamber 11 being depressurized. The substrate W and the sheet film F continue to be heated to be kept at a predetermined temperature during that time. Since the relative tilt of the second plate 5 relative to the first plate 4 has been corrected, the thin film can be transferred to the substrate W in a condition that the pressure distribution within the surface is kept uniform.

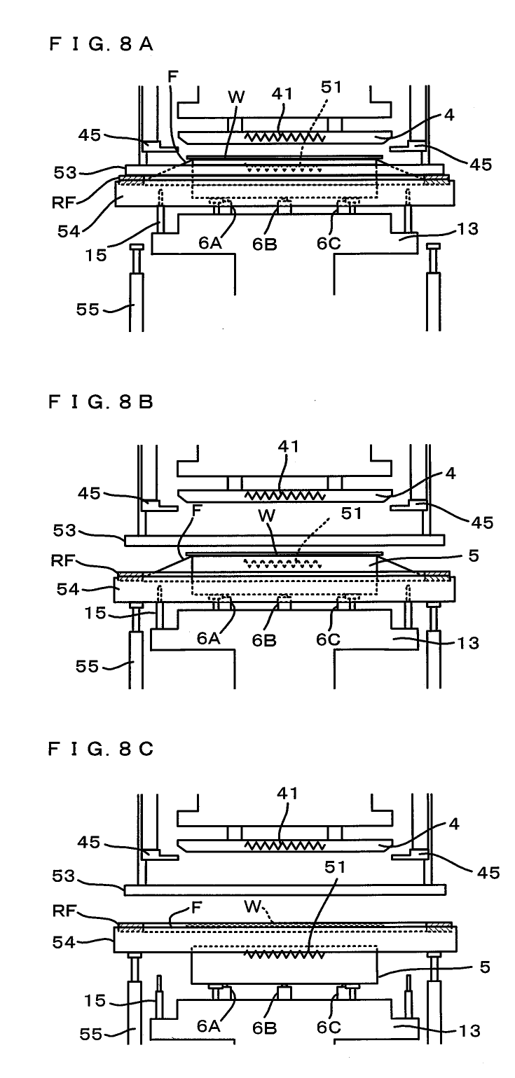

When a series of pressure loading operations are ended and the transfer processing is completed, the heater controllers 42 and 52 stop an operation of the heaters 41 and 51 to stop heating the first and the second plates 4 and 5. Simultaneously, the tab members 45 are laterally moved away to release the retention of the substrate by means of the tab members 45 (FIG. 7C). Subsequently, the control unit 10 sends a signal to the loading motor 14 to integrally descend the top clamp 53, the ring unit RF and the bottom clamp 54 which are supported on the base member 13, the second plate 5, and the base member 13 so that the loading level becomes zero (FIG. 8A). Then, the ring unit RF is separated from the top clamp 53 with the descent of the base member 13 (FIG. 8B). The base member 13 is descended further, and when the second plate 5 (and the base member 13) is returned to the initial position prior to the transfer processing, the clamp raising pins 15 are separated from the bottom clamp 54. The bottom clamp 54 and the ring unit RF are thus placed on the clamp receivers 55 (FIG. 8C). Further, after the second plate 5 is returned to the initial position prior to the transfer processing, the vacuum pump 2 is stopped.

Meanwhile, when the thin film is adhered to the substrate in the thin film forming apparatus as described above, the substrate W is integrated with the sheet film F sandwiching the thin film therebetween. While keeping the integrated state, the ring unit RF is taken out of the thin film forming chamber 11 and is transported to a peeling apparatus (not shown) in which the sheet film F is peeled off.

As described above, according to this embodiment, the second plate 5 is supported by the three supporting members 6A, 6B and 6C which are disposed in a circle around the axis which extends in the moving direction Z and passes through the center of the top surface 5a of the second plate 5. And, the second plate 5 is arranged to be displaced in the moving direction Z by controlling the length of each of the supporting members 6A, 6B and 6C in the moving direction Z at the supporting portion (abutting portion 62A) at which the second plate 5 is supported by each of the supporting members 6A, 6B and 6C. Hence, the relative tilt of the second plate 5 relative to the first plate 4 can be corrected by having each of the supporting members 6A, 6B, 6C displace the second plate 5 in the moving direction Z before the transfer processing. Therefore, it is possible to stably perform the tilt correction regardless of a state of setting up of the apparatus, and to transfer the thin film to the substrate W with the pressure distribution within the surface being uniform. Further, correcting the relative tilt of the second plate 5 relative to the first plate 4 before transfer processing allows the thin film to adhere to the substrate W across the entire surface virtually simultaneously. Therefore, it is possible to prevent the problems which occur when the thin film starts to adhere to the substrate W from a limited region within the surface. One example of the problems is that the thin film adheres to the substrate W in a condition that dried condition of the thin film is uneven within the surface.

Further, according to this embodiment, the supporting members 6A, 6B and 6C include the extensible portions 61A, 61B and 61C which extend and contract in the moving direction Z, respectively. The second plate 5 is displaced by independently controlling the driving of the extensible portions 61A, 61B and 61C. Hence, the extension and the contraction of the supporting members 6A, 6B, 6C enable the relative tilt of the second plate 5 relative to the first plate 4 to be adjusted freely. Particularly, according to this embodiment, piezo actuators are used for the extensible portions 61A, 61B and 61C. The length in the moving direction Z of each of the piezo actuators is controlled by controlling the voltage applied to each of the piezo actuators. Since the piezo actuator has a relatively large thrust force and is capable of performing microscopic level of extension and contraction driving (determined by resolution ability of the applied voltage and is capable of making adjustment in nanometer order), use of the piezo actuators for the extensible portions 61A, 61B and 61C enables minimal tilt control of the second plate 5 relative to the first plate 4.

In other words, this embodiment is a thin film forming apparatus which comprises: a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film; a transferring unit that moves at least one of the first and the second plates in the moving direction, presses the substrate and the carrier to each other, and performs a transfer processing to transfer the thin film to the substrate; a plurality of supporting members which are disposed in a circle about an axis extending in the moving direction and passing through a center of the opposed surface of the second plate, are arranged to be able to adjust lengths in the moving direction thereof while supporting the second plate at supporting portions thereof; and a controller that controls the lengths of the respective supporting members in the moving direction at the supporting portion prior to the transfer processing or during the transfer processing to displace the second plate in the moving direction so that a relative tilt of the second plate relative to the first plate is coffected.

In still other words, this embodiment is a thin film forming method using a thin film forming apparatus which comprises: a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film; and a plurality of supporting members which are disposed in a circle about an axis extending in the moving direction and passing through a center of the opposed surface of the second plate, are arranged to be able to adjust lengths in the moving direction thereof while supporting the second plate at supporting portions thereof, the method comprises: a transferring step of moving at least one of the first and the second plates in the moving direction, pressing the substrate and the carrier to each other, and performing a transfer processing to transfer the thin film to the substrate; and a tilt correction step of controlling the lengths of the respective supporting members in the moving direction at the supporting portion prior to the transferring step or during the transferring step to displace the second plate in the moving direction so that a relative tilt of the second plate relative to the first plate is corrected.

According to this embodiment arranged in a manner described above, the second plate is supported by the plurality of supporting members, at supporting portions thereof, which are disposed in a circle about the axis extending in the moving direction and passing through the center of the opposed surface of the second plate, and are arranged to be able to adjust lengths in the moving direction thereof. Further, the lengths of the respective supporting members in the moving direction at the supporting portion prior to the transfer processing or during the transfer processing. Thus, the second plate is displaced in the moving direction, and hence, the relative tilt of the second plate relative to the first plate is corrected. Therefore, the tilt correction can be performed in accordance with the state of the setting up of the apparatus. As a result, it is possible to stably perform the tilt correction regardless of the state of setting up of the apparatus, and hence, it is possible to transfer the thin film to the substrate with a uniform pressure distribution within the surface.

In this embodiment, each of the supporting members includes an extensible portion which extends and contracts in the moving direction, and the controller drives to extend or contract each of the extensible portions independently to control the length of each of the supporting members in the moving direction. According to this arrangement, the extensible portions of the supporting members are driven to extend or contract independently, and hence, the relative tilt of the second plate relative to the first plate can be changed freely.

Further, in this embodiment, a piezo actuator is used as each of the extensible portions, and the controller controls a voltage applied to each of the piezo actuators to drive to extend or contract each of the piezo actuators. Since the piezo actuator has a relatively large thrust force and is capable of performing microscopic level of extension and contraction driving, use of the piezo actuators for the extensible portions enables minimal tilt control of the second plate relative to the first plate.

### Second Embodiment

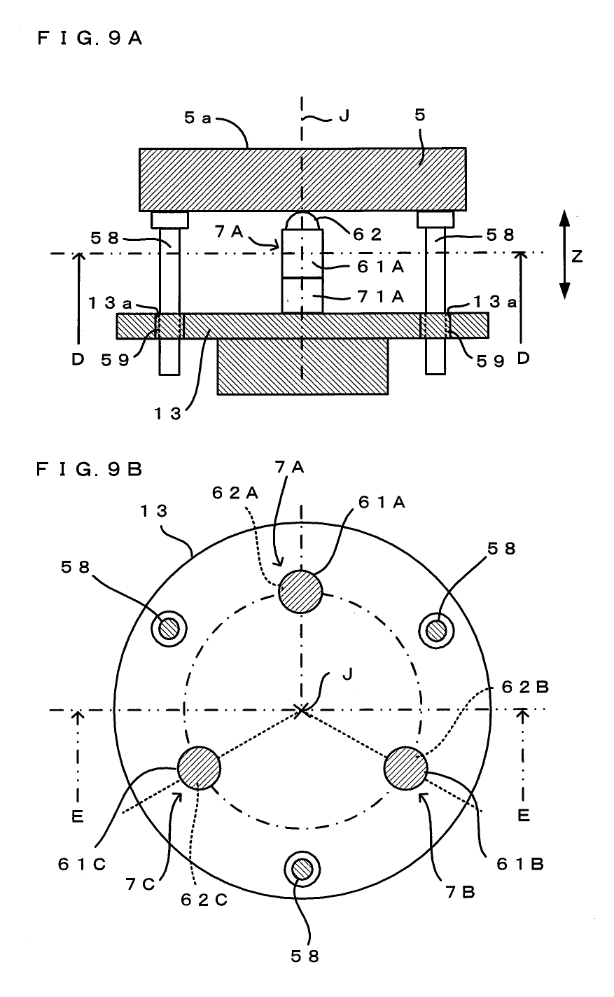

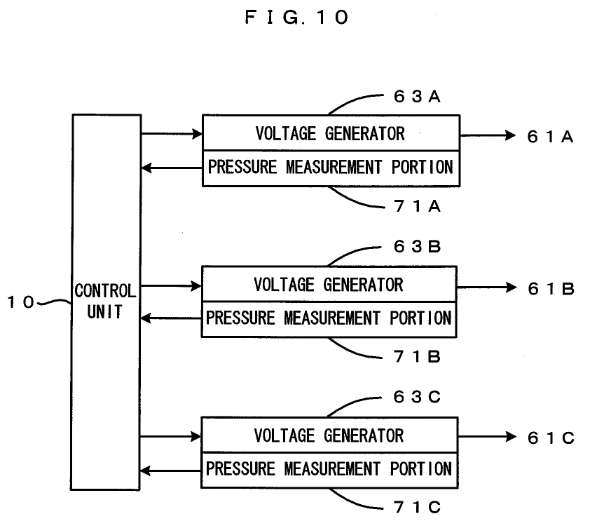

FIGS. 9A and 9B are diagrams showing main parts of a second embodiment of the thin film forming apparatus according to the invention. Further, FIG. 10 is a block diagram showing a part of a control arrangement for controlling the thin film forming apparatus of FIGS. 9A and 9B. Here, FIG. 9A is a longitudinal sectional view (longitudinal sectional view taken on line E-E of FIG. 9B) and FIG. 9B is a transverse sectional view (transverse sectional view taken on line D-D of FIG. 9A). The thin film forming apparatus according to the second embodiment principally differs from that of the first embodiment in that supporting members 7A, 7B, 7C include pressure measurement portions 71A, 71B, 71C (equivalent to “pressure measurement unit” of the invention) between the extensible portions 61A, 61B, 61C and the base member 13, respectively, and in that displacement of the second plate 5 by the supporting members 7A, 7B, 7C is controlled based on the measurement pressure measured by the pressure measurement portions 71A, 71B, 71C. Meanwhile, other arrangements and operations are basically similar to those of the first embodiment.

In this embodiment, the pressure measurement portions 71A, 71B, 71C are disposed between the extensible portions 61A, 61B, 61C and the base member 13 in the respective supporting members 7A, 7B and 7C. The pressure measurement portions 71A, 71B and 71C are embedded below the extensible portions 61A, 61B and 61C, respectively, and measure the pressure loaded in the moving direction Z. A piezoelectric sensor, for example, is used for each of the pressure measurement portions 71A, 71B and 71C. A signal (pressure signal) corresponding to the voltage generated in accordance with the pressure loaded on the piezoelectric sensor is sent to the control unit 10. The control unit 10 compares the pressure (hereinafter called “measured pressure”) measured by each of the pressure measurement portions 71A, 71B and 71C with a predetermined pressure. Here, the predetermined pressure means a pressure which is set in advance and is suitable for transfer processing. When there is a difference between the two, each of the voltage generators 63A, 63B and 63C is controlled individually so that the measured pressure by each of the pressure measurement portions 71A, 71B and 71C is equal to the predetermined pressure. Specifically, in the case where the measured pressure measured by the pressure measurement portion 71A is lower than the predetermined pressure, the control unit 10 provides a voltage control command to the voltage generator 63A so as to extend the extensible portion 61A. On the other hand, in the case where the measured pressure measured by the pressure measurement portion 71A is higher than the predetermined pressure, the control unit 10 provides a voltage control command to the voltage generator 63A so as to contract the extensible portion 61A. In the same way, the control unit 10 provides voltage control commands to the voltage generators 63B and 63C so as to extend or to contract the extensible portions 61B and 61C based on the measured pressures measured by the pressure measurement portions 71B and 71C, respectively.

It is to be noted that various pressure sensors such as semiconductor type pressure sensors, quartz oscillator type pressure sensors and capacitance type pressure sensors can be used other than the piezoelectric sensors (piezoelectric type pressure sensor) for the pressure measurement portions 71A, 71B and 71C. It is particularly desirable to use a piezoelectric sensor for the pressure sensor because it is compact in size and is suitable to measure dynamic load.

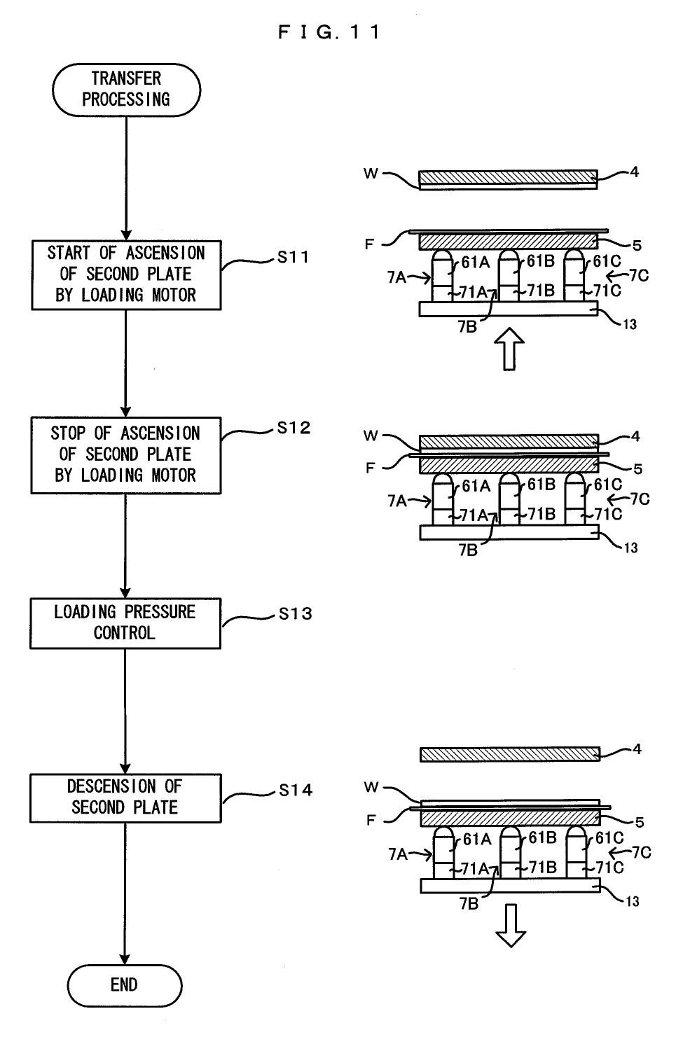

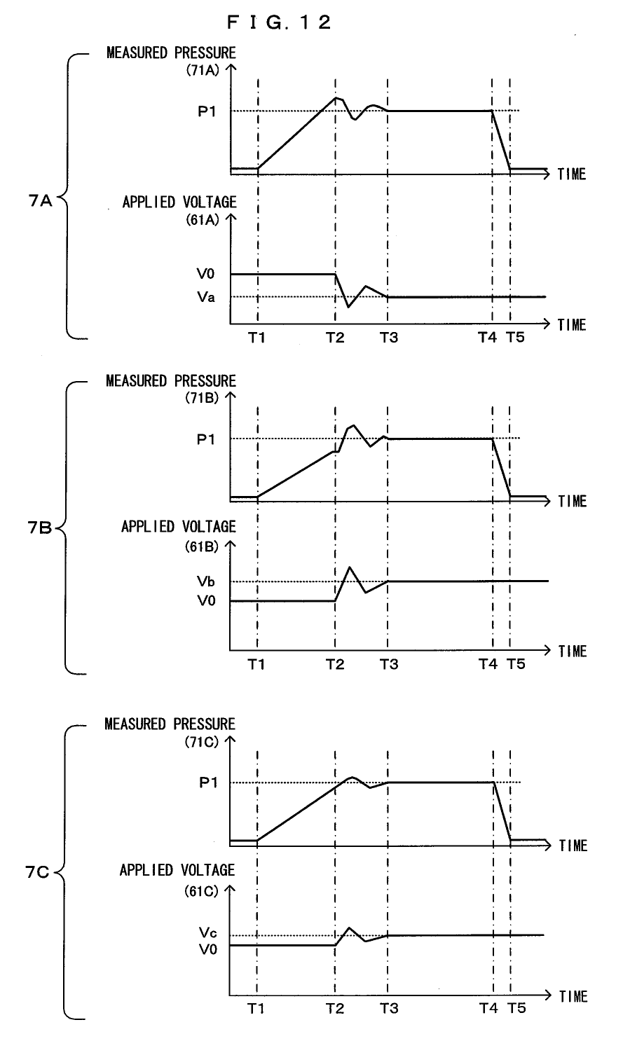

Next, description is made on the transfer processing (transferring step) performed by using the above-mentioned thin film forming apparatus with reference to FIGS. 11 and 12. FIG. 11 is a flow chart showing an operation of the transfer processing of the thin film forming apparatus of FIG. 9. FIG. 12 is a timing chart showing a state of loading pressure and of applied voltage in each of the supporting members. In this embodiment, in the same manner as the first embodiment, when the loading and mounting of the substrate W and the sheet film F are completed, the control unit 10 controls the respective parts of the apparatus according to the transferring program so as to transfer the thin film to the substrate W as described below. It is to be noted that the heaters 41 and 51 are already turned on (heating state) and the thin film forming chamber 11 is already depressurized. Further, in this embodiment, predetermined initial voltages are applied to the extensible portions 61A, 61B and 61C in advance.

At first, the control unit 10 sends a signal to the loading motor 14, and an ascent of the second plate 5 (and the base member 13) is started (Step S11). Hence, the second plate 5 is moved in a relatively wide range in the moving direction Z, and the thin film on the sheet film F starts to contact with the substrate W (Timing T1). Then, at the point when the measured pressure measured by either one of the pressure measurement portions 71A, 71B and 71C exceeds a certain threshold value, it is determined that the thin film on the sheet film F is completely in contact with the substrate W, and the ascent of the second plate 5 by the loading motor 14 is stopped (Step S12).

Subsequently, the control unit 10 provides a voltage control command to the voltage generators 63A, 63B and 63C so that the measured pressure measured by the pressure measurement portions 71A, 71B and 71C are equal to the predetermined pressure P1. Specifically, the voltage in accordance with the voltage control command is applied to the extensible portions 611A, 611B and 61C, and the driving of the extension and the contraction (fine adjustment of the length of the supporting members 7A, 7B and 7C in the moving direction Z) of the extensible portions 61A, 61B and 61C in accordance with the applied voltage is started (Timing T2). Thus, pressure control is performed so that the pressure loaded on the pressure measurement portions 71A, 71B and 71C in the moving direction Z is uniform (Step S13: tilt correction step). At this time, the extensible portions 61A, 61B and 61C function not only as pressure controllers but also as pressurizing units which press the second plate 5 to the first plate 4 to transfer the thin film to the substrate W. Meanwhile, in the case where the pressure loaded from the extensible portions 61A, 61B and 61C does not reach the predetermined pressure P1, the loading motor 14 may be activated to ascend the second plate 5 supplementarily.

Here, description is made on a specific operation of the pressure control by means of the respective supporting members 7A, 7B and 7C with reference to FIG. 12. In the case where the measured pressure of the pressure measurement portion 71A is higher than the predetermined pressure P1 at the timing when the second plate 5 stops ascending (Timing T2), that is, in the case where the second plate 5 is tilted upward at the supporting portion (abutting portion 62A) at which the second plate 5 is supported by the supporting member 7A for example, the applied voltage is decreased from the initial voltage V0 so as to contract the extensible portion 61A. Thus, feedback control of the displacement amount of the second plate 5 by the supporting member 7A is performed so that the measured pressure is equal to the predetermined pressure P1. On the other hand, in the case where the measured pressures of the pressure measurement portions 71B and 71C are lower than the predetermined pressure P1 at the timing when the second plate 5 stops ascending (Timing T2), that is, in the case where the second plate 5 is tilted downward at the supporting portions (abutting portions 62B and 62C) at which the second plate 5 is supported by the supporting members 7B and 7C, the applied voltage is increased from the initial voltage V0 so as to extend the extensible portions 61B and 61C. Thus, feedback control of the displacement amounts of the second plate 5 by the supporting members 7B and 7C is performed so that the measured pressures are equal to the predetermined pressure P1. Meanwhile, although the measured pressure of the pressure measurement portion 71B is lower than the measured pressure of the pressure measurement portion 71C, the applied voltage is controlled individually in accordance with the difference between each measured pressure and the predetermined pressure P1. As a result, measured pressures of the respective pressure measurement portions 71A, 71B and 71C are gradually converged to the predetermined pressure P1. Hence, the relative tilt of the second plate 5 relative to the first plate 4 is corrected.

When each of the measured pressures of the pressure measurement portions 71A, 71B and 71C becomes equal to the predetermined pressure P1, the driving of extension and contraction of the extensible portions 61A, 61B and 61C is stopped (Timing T3). While keeping this state, the second plate 5 is pressure-loaded to the first plate 4 for a predetermined time. At this time, the substrate W and the thin film on the sheet film F are pressed to each other uniformly across the entire surfaces.

Then, when the pressure loading operation described above is completed (Timing T4), the second plate 5 is descended by the loading motor 14 so that the loading pressure becomes zero, that is, the measured pressure of the pressure measurement portions 71A, 71B and 71C becomes the pressure level before the start of contact (Step S14). As a result, the measured pressure of the pressure measurement portions 71A, 71B and 71C decreases to the pressure level before the start of contact (Timing T5). Subsequently, in the same manner as the first embodiment, after the second plate 5 returns to the initial position before the transfer processing, the vacuum pump 2 is stopped and the substrate W that is integrated with the sheet film F sandwiching the thin film therebetween is taken out from the thin film forming chamber 11.

As described above, according to this embodiment, it is structured that the length of each of the supporting members 7A, 7B and 7C in the moving direction Z is controlled at each of the supporting portions (abutting portions 62A, 62B and 62C) of the supporting members 7A, 7B and 7C while the three supporting members 7A, 7B and 7C support the second plate 5, whereby the second plate 5 is displaced in the moving direction Z in the same manner as the first embodiment. Hence, it is possible to obtain the same effect as the first embodiment. Further, the displacement amount of the second plate 5 by each of the supporting members 7A, 7B and 7C is controlled so that each of the measured pressures measured by the pressure measurement portions 71A, 71B and 71C during the transfer processing of the thin film to the substrate W becomes equal to the predetermined pressure P1. This improves uniformity in pressure distribution within the surface during the transfer processing. Furthermore, even if individual variability exists in the thickness of the substrate W in the moving direction Z, the thin film can be transferred to the substrate W while keeping the uniformity of the pressure distribution within the surface.

Further, according to this embodiment, the substrate W and the sheet film F are pressed to each other in two stages using two pressure loading units, that is, the loading motor 14 and the supporting members 7A, 7B, 7C to transfer the thin film to the substrate W. Specifically, (1) the loading motor 14 moves the second plate 5 in the moving direction Z in a relatively wide range until the substrate W and the thin film on the sheet film F come into contact with each other, and then, (2) each of the supporting members 7A, 7B, 7C instead of the loading motor 14 presses the second plate 5 toward the first plate 4 finely while correcting the relative tilt of the second plate 5 relative to the first plate 4 so that the thin film is transferred to the substrate W. Therefore, it is possible to press the substrate W and the sheet film F to each other with high precision, while making it possible to move the plate in a relatively wide range. Hence, excessive precision is not required for the loading motor 14, and the loading motor can be arranged at a low cost.

In other words, in this embodiment, each of the supporting members includes a pressure measurement unit that measures a pressure loaded in the moving direction, and the controller controls the length of each of the supporting members in the moving direction so that a measured pressure measured by each of the pressure measurement units during the transfer processing equals to a predetermined pressure which is set in advance. According to this arrangement, the length of each of the supporting members in the moving direction is controlled so that a measured pressure measured by each of the pressure measurement units during the transfer processing equals to a predetermined pressure. Hence, it is possible to improve uniformity in a pressure distribution within the surface when the transfer processing is performed. Further, even if individual variability exists in the thickness of the substrate in the moving direction, the thin film can be transferred to the substrate while keeping the uniformity of the pressure distribution within the surface.

In this embodiment, the apparatus further comprising a moving mechanism that moves at least one of the first and the second plates in the moving direction toward the other, wherein the controller stops the plate movement by the moving mechanism when the pressure measurement unit detects that the substrate comes into contact with the thin film on the carrier by the plate movement by the moving mechanism, controls the length of each of the supporting members in the moving direction, while correcting the relative tilt of the second plate relative to the first plate, to press the second plate toward the first plate so that the substrate and the carrier are pressed to each other to transfer the thin film to the substrate.

According to this arrangement, the substrate and the carrier are pressed to each other in two stages using two pressure loading units, that is, the moving mechanism and the supporting members to transfer the thin film to the substrate. Specifically, (i) the moving mechanism moves at least one of the first and the second plates in the moving direction toward the other plate in a relatively wide range until the substrate and the thin film on the carrier come into contact with each other, and then, (ii) each of the supporting members instead of the moving mechanism presses the second plate toward the first plate finely while correcting the relative tilt of the second plate relative to the first plate so that the thin film is transferred to the substrate. Therefore, it is possible to press the substrate and the carrier to each other with high precision, while making it possible to move the plate in a relatively wide range.

### Others

The present invention is not limited to the preferred embodiments described above but may be modified in a variety of manners to the extent not departing from the spirit of the invention. For instance, in the above embodiments, the second plate 5 is arranged below the first plate 4, and the top surface 5a of the second plate 5 is opposed to the first plate 4 as the “opposed surface”. Alternatively, the second plate 5 may be arranged above the first plate 4, and the bottom surface of the second plate 5 may be opposed to the first plate 4 as the “opposed surface”.

Further, in the above embodiments, the first plate 4 is used as the substrate plate by mounting the substrate W thereto, and the second plate 5 is used as the film plate by mounting the sheet film F thereto. However, the application of the invention is not limited to this, the first plate 4 may be used as the film plate and the second plate 5 may be used as the substrate plate.

Further, in the above embodiments, the second plate 5 is moved to press against the first plate 4 using the loading motor 14. However, the first plate 4 may be moved, or both of the first and the second plates 4 and 5 may be moved to press against each other. Any arrangement can be adopted as long as the first and the second plates 4 and 5 are pressed to each other.

Further, in the above embodiments, the ring unit RF is composed by sandwiching the sheet film F between the pair of rings Rup and Rdw, and the ring unit RF is loaded into the thin film forming chamber 11, whereby the sheet film F is transported. However, the transportation mode of the sheet film F is not limited to this. The sheet film F may be directly loaded into the thin film forming chamber 11, for instance.

Further, in the above embodiments, the sheet film F is used as a “carrier” provided with a thin film. However, inflexible plate-like member, a quartz plate for instance, may be used as a “carrier” instead of the sheet film F. When the inflexible plate-like member is used as a “carrier”, the inflexible plate-like member can be reused after the thin film is peeled off.

Further, in the above embodiments, the length of each of the supporting members in the moving direction is controlled by extending or contracting each of the supporting members 6A, 6B and 6C (or 7A, 7B and 7C) to displace the second plate 5. However, depending on the acceptable accuracy of the pressure distribution within the surface and the like for instance, the supporting members may be arranged to extend only and the length of the supporting members in the moving direction may be controlled only by extending the supporting members, or the supporting members may be arranged to contract only and the length of the supporting members in the moving direction may be controlled only by contracting the supporting members.

Further, in the above first embodiment, the description is made in the case where the tilt correction is performed immediately after setting up the apparatus. However, the invention may also be applied to a case where the tilt due to deterioration with age of the apparatus is corrected. For example, there is a case that deformation develops in the apparatus after the transfer processing is performed more than once, which makes the second plate 5 relatively tilt relative to the first plate 4. Consequently, steps S2-S4 (FIG. 5) may be performed after the transfer processing is performed a predetermined number of times (100,000 times for example) or after a predetermined time passes, whereby the relative tilt of the second plate 5 relative to the first plate 4.

Further, in the above second embodiment, the description is mainly made in the case where the transfer processing (hereinafter called “the first transfer processing”) is performed immediately after the setting up of the apparatus or immediately after the turning on of the apparatus. However, in the case where the second transfer processing is performed following the first transfer processing, it is possible to perform the transfer processing in a condition that a certain level of tilt correction is already executed. For instance, the initial voltage V0 is applied to each of the extensible portions 61A, 61B and 61C prior to the loading operation (until the Timing T2) in FIG. 12. But, the adjusted voltages Va, Vb and Vc are applied to the respective extensible portions 61A, 61B and 61C after the relative tilt of the second plate 5 relative to the first plate 4 is corrected (after the Timing T3).

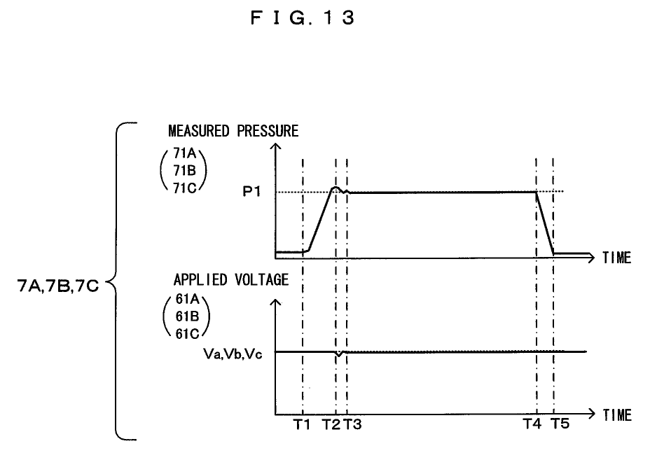

Therefore, as shown in FIG. 13, the adjusted voltages Va, Vb and Vc are applied in advance to the extensible portions 61A, 61B and 61C, respectively in the second transfer processing, whereby the relative tilt of the second plate 5 relative to the first plate 4 is quickly corrected. Specifically, the measured pressures measured by the pressure measurement portions 71A, 71B and 71C at the time when the ascent of the second plate 5 is stopped (at the Timing T2) almost equal the predetermined pressure P1, and hence, it is enough to perform a minimal pressure control in accordance with the individual variability and the like of the substrate W thereafter. Therefore, the substrate W and the thin film formed on the sheet film F can be pressed to each other in a state that the pressure within the surface is uniform from the very beginning. From this standpoint, it is desirable to perform the first transfer processing using a dummy substrate and a dummy sheet film, whereas it is desirable to perform the second transfer processing and thereafter using the substrate W and the sheet film F which are to be used for actual production.

Further, in the above first embodiment, the three supporting members 6A, 6B and 6C include the extensible portions 61A, 61B and 61C, respectively, and the second plate 5 is displaced in the moving direction Z at the supporting portion of each of the supporting members 6A, 6B and 6C by driving to extend or contract each of the extensible portions 61A, 61B and 61C. However, the invention is not limited to this. For instance, it may be arranged that only the two supporting members 6A and 6B out of the three supporting members 6A, 6B and 6C are provided with the extensible portions 61A and 61B, and that the remaining supporting member 6C is a fixed supporting member. Specifically, it may be arranged that the second plate 5 is displaced only by the two supporting members. In this case, for instance, after the second plate 5 is pressed to the first plate 4 by activating the loading motor 14, the second plate 5 may be displaced using the remaining supporting members 6A and 6B to match the loading pressure at the supporting portion of the supporting member 6C (fixed supporting member) to make the pressure distribution within the surface uniform. Similarly, also in the above second embodiment, it may be arranged that the second plate 5 can be displaced using only the two supporting members out of the three supporting members 7A, 7B and 7C. In this case, for instance, after the measured pressure at the pressure measurement portion corresponding to the fixed supporting member is equalized with the predetermined pressure by activating the loading motor 14, the second plate 5 may be displaced using the remaining two supporting members so that the measured pressures at the pressure measurement portions corresponding to the remaining two supporting members are equal to the predetermined pressure. It is thus possible to make the pressure distribution within the surface uniform.

Further, more than three supporting members which can displace the second plate 5 may be provided. In this case, the placed positions of the supporting members are arbitrary as long as they are placed in a circle about the central axis J.

Further, the invention is not limited to the case where the thin film is transferred to the semiconductor substrate. It is also applicable to the case where the thin film is transferred to a substrate relating to an electronic component material including a substrate for mounting such as a multi-chip module and a substrate for liquid crystal. Further, the thin film is not limited to the insulating film. A metallic thin film may be transferred to a substrate.

This invention is applicable to the thin film forming apparatus and the thin film forming method for forming thin films on the substrates including semiconductor wafers, glass substrates for photomask, glass substrates for liquid crystal display, glass substrates for plasma display, substrates for FED (field emission display), substrates for optical disc, substrates for magnetic disc, substrates for optical magnetic disc.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A thin film forming apparatus, comprising:
a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film;
a transferring unit that moves at least one of the first and the second plates in the moving direction, presses the substrate and the carrier to each other, and performs a transfer processing to transfer the thin film to the substrate;
a plurality of supporting members which are disposed in a circle about an axis extending in the moving direction and passing through a center of the opposed surface of the second plate, are arranged to be able to adjust lengths in the moving direction thereof while supporting the second plate at supporting portions thereof; and
a controller that controls the lengths of the respective supporting members in the moving direction at the supporting portion prior to the transfer processing or during the transfer processing to displace the second plate in the moving direction so that a relative tilt of the second plate relative to the first plate is corrected.

2. The thin film forming apparatus of claim 1, wherein
each of the supporting members includes an extensible portion which extends and contracts in the moving direction, and
the controller drives to extend or contract each of the extensible portions independently to control the length of each of the supporting members in the moving direction.

3. The thin film forming apparatus of claim 2, wherein
a piezo actuator is used as each of the extensible portions, and
the controller controls a voltage applied to each of the piezo actuators to drive to extend or contract each of the piezo actuators.

4. The thin film forming apparatus of claim 1, wherein each of the supporting members includes a pressure measurement unit that measures a pressure loaded in the moving direction, and
the controller controls the length of each of the supporting members in the moving direction so that a measured pressure measured by each of the pressure measurement units during the transfer processing equals to a predetermined pressure which is set in advance.

5. The thin film forming apparatus of claim 4, further comprising a moving mechanism that moves at least one of the first and the second plates in the moving direction toward the other, wherein
the controller stops the plate movement by the moving mechanism when the pressure measurement unit detects that the substrate comes into contact with the thin film on the carrier by the plate movement by the moving mechanism, controls the length of each of the supporting members in the moving direction, while correcting the relative tilt of the second plate relative to the first plate, to press the second plate toward the first plate so that the substrate and the carrier are pressed to each other to transfer the thin film to the substrate.

6. A thin film forming method using a thin film forming apparatus which comprises:
a first and a second plates which are arranged opposed to each other, have opposed surfaces respectively, and are relatively movable relative to each other in a predetermined moving direction, the opposed surface of one of the plates having a substrate mounted thereon, the opposed surface of the other plate having a carrier mounted thereon, the carrier including a thin film; and
a plurality of supporting members which are disposed in a circle about an axis extending in the moving direction and passing through a center of the opposed surface of the second plate, are arranged to be able to adjust lengths in the moving direction thereof while supporting the second plate at supporting portions thereof, the method comprising:
a transferring step of moving at least one of the first and the second plates in the moving direction, pressing the substrate and the carrier to each other, and performing a transfer processing to transfer the thin film to the substrate; and
a tilt correction step of controlling the lengths of the respective supporting members in the moving direction at the supporting portion prior to the transferring step or during the transferring step to displace the second plate in the moving direction so that a relative tilt of the second plate relative to the first plate is corrected.
